(19) United States
(12) Patent Application Publication
(10) Pub. No.: US 2016/0202583 A1
(43) Pub. Date: Jul. 14, 2016

(54) LIQUID CRYSTAL DISPLAY

(71) Applicant: Samsung Display Co., Ltd., Yongin-si (KR)

(72) Inventors: Kwang-Chul JUNG, Seongnam-si (KR); Sun Hwa LEE, Yongin-si (KR); Sang-Uk LIM, Yongin-si (KR); Mee Hye JUNG, Suwon-si (KR)

(21) Appl. No.: 14/790,565

(22) Filed: Jul. 2, 2015

(30) Foreign Application Priority Data
Jan. 8, 2015 (KR) 10-2015-0002966

(51) Int. Cl. G02F 1/1362; G02F 1/1343; G02F 1/1368

(52) U.S. Cl. CPC G02F 1/136286; G02F 1/1368; G02F 1/136227; G02F 1/134336; G02F 1/13624; G02F 2001/134345

(57) ABSTRACT

A liquid crystal display including a plurality of gate lines and a plurality of data lines that is insulated from and cross the plurality of gate lines, and a plurality of unit pixels connected to the plurality of gate lines and the plurality of data lines, wherein the plurality of unit pixel includes a first pixel at row 1 and column 1, a second pixel at row 1 and column 2, a third pixel at row 2 and column 1, and a fourth pixel at row 2 and column 2, a first gate line and a second gate line are disposed in parallel to each other between the first pixel and the third pixel and between the second pixel and the fourth pixel, and the first gate line is connected to the first pixel and the third pixel at different neighboring rows, and the second gate line is connected to the second pixel and the fourth pixel at different neighboring rows.

### CLAIM OF PRIORITY

This application claims priority to and the benefit of Korean Patent Application No. 10-2015-0002966 filed in the Korean Intellectual Property Office on Jan. 8, 2015, the entire contents of which are incorporated herein by reference.

### BACKGROUND OF THE INVENTION

1. Field of Disclosure

The present invention generally relates to a liquid crystal display.

2. Description of the Related Art

The present invention generally relates to a driving apparatus of a liquid crystal display, and more particularly, a driving apparatus of a liquid crystal display for removing horizontal crosstalk.

A general liquid crystal display includes two display panels and a liquid crystal layer with dielectric anisotropy, positioned between the two display panels. An electric field is applied to a liquid crystal layer and intensity of the electric field is adjusted so as to adjust transmittance of light passing through the liquid crystal layer and to capture a desired image. The liquid crystal display is a representative example of an easily portable flat panel display (FPD), and among liquid crystal displays, a thin film transistor-liquid crystal display (TFT-LCD) using a TFT as a switching element has been mainly used.

The above information disclosed in this Related Art section is only for enhancement of understanding of the background of the invention and therefore it may contain information that does not form the prior art that is already known in this country to a person of ordinary skill in the art.

### SUMMARY OF THE INVENTION

In this case, when a 2 dot inversion method is used for a RGBW pixel structure, a problem arises in that horizontal unevenness is generated by forming different widths of light blocking members between neighboring pixels in a column direction.

In addition, a problem arises in that deviation in kickback voltage Vkb is generated by parasitic capacitance between a gate line and a pixel electrode when a first insulation substrate and a second insulation substrate are misaligned.

The present invention has been made in an effort to provide a liquid crystal display having advantages of improving image quality by reducing horizontal unevenness and deviation in kickback voltage.

An exemplary embodiment of the present invention provides a liquid crystal display including a plurality of gate lines and a plurality of data lines that are insulated from and cross the plurality of gate lines, and a plurality of unit pixels connected to the plurality of gate lines and the plurality of data lines, wherein the plurality of unit pixels include a first pixel at row 1 and column 1, a second pixel at row 1 and column 2, a third pixel at row 2 and column 1, and a fourth pixel at row 2 and column 2, a first gate line and a second gate line are disposed in parallel to each other between the first pixel and the third pixel and between the second pixel and the fourth pixel, and the first gate line is connected to the first pixel and the third pixel at different neighboring rows, and the second gate line is connected to the second pixel and the fourth pixel at different neighboring rows.

The first gate lines that are adjacent to each other in a column direction may be connected to each other outside a pixel area, and the second gate lines that are adjacent to each other in a column direction may be connected to each other outside a pixel area.

The plurality of data lines may be disposed between a plurality of pixels that are adjacent to each other in a row direction, and a plurality of pixels disposed in a row direction may alternately have positive polarity (+) and negative polarity (−).

The positive polarity (+) and the negative polarity (−) may be opposite polarities to common voltages of data voltages applied to the plurality of data lines.

The plurality of data lines may be alternately connected to a plurality of pixels disposed in a column direction in a zigzag form.

The column direction may be a downward direction from above and the row direction may be a right direction from the left

The unit pixel may be divided by the gate line and the data line that cross each other.

The first pixel may be a red display pixel, the second pixel may be a green display pixel, the third pixel may be a blue display pixel, and the fourth pixel may be a white display pixel.

The plurality of pixels may include a first subpixel electrode and a second subpixel electrode.

The first gate line and the second gate line may be disposed in parallel to each other between the first subpixel electrode and the second subpixel electrode.

The liquid crystal display may further include a first thin film transistor connected to the first subpixel electrode, a second thin film transistor connected to the second subpixel electrode, and a third thin film transistor connected to the second thin film transistor and a reference voltage line.

The first to third thin film transistors may include a gate electrode, a semiconductor layer, and source electrode and drain electrodes, and the drain electrode and the first and second subpixel electrode may be connected to each other through a contact hole.

The first thin film transistor, the second thin film transistor, and the third thin film transistor may be positioned on the first gate line or the second gate line.

The contact hole may be disposed between the first and second gate lines and the first and second subpixel electrodes.

The first thin film transistor, the second thin film transistor, the third thin film transistor, and the contact hole may be disposed between the first gate line and the second gate line.

The first thin film transistor, the second thin film transistor, the third thin film transistor, and the contact hole may be disposed in parallel to each other in a horizontal direction.

It is to be understood that both the foregoing general description and the following detailed description of the present invention are exemplary and explanatory and are intended to provide further explanation of the invention as claimed.

According to the aforementioned exemplary embodiment of the present invention, the following effects may be achieved.

The liquid crystal display according to the present invention may include a first gate line and a second gate line that are disposed in parallel to each other in a pixel area, the first gate line G1 and the second gate line G2 may be simultaneously connected to pixels that are adjacent thereto in a column direction, respectively, the first gate line may be connected to one pixel that is adjacent thereto in a row direction, and the second gate line may be connected to the other pixel that is adjacent thereto in a row direction such that light blocking members between the pixels adjacent to each other in a column direction have the same width so as to reduce horizontal unevenness and to reduce deviation in a kickback voltage generated by parasitic capacitance between terminals of a switching element, thereby improving image quality.

The liquid crystal display according to the present invention is configured in such a way that a first thin film transistor, a second thin film transistor, a third thin film transistor, and a contact hole are disposed in parallel to each other in a horizontal direction so as to reduce the width of a light blocking member, thereby improving an aperture ratio and reducing a parasitic capacitor between a gate line and a drain electrode.

In addition, according to exemplary embodiments of the present invention, other features and advantages may be newly recognized.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a schematic diagram illustrating signal wires and pixel arrangement according to an exemplary embodiment of the present invention.

FIG. 2 is a circuit diagram of one pixel of a liquid crystal display according to an exemplary embodiment of the present invention.

FIG. 3 is a top plan view of a unit pixel of a liquid crystal display according to an exemplary embodiment of the present invention.

FIG. 4 is a cross-sectional view taken along a line IV-IV of FIG. 3.

FIG. 5 is a cross-sectional view taken along a line V-V of FIG. 3.

FIG. 6 is a top plan view illustrating one basic region of a field generating electrode of a liquid crystal display according to an exemplary embodiment of the present invention.

FIG. 7 is a plane view of a unit pixel of a liquid crystal display according to another exemplary embodiment of the present invention.

FIG. 8 is a schematic diagram of signal wires and pixel arrangement according to Comparative Example of the present invention.

FIG. 9 is a plan view of a unit pixel of a liquid crystal display according to Comparative Example of the present invention.

FIG. 10 is a drawing illustrating horizontal unevenness of a liquid crystal display according to Comparative Example of the present invention.

FIG. 11 is a drawing for explanation of deviation of a kickback voltage of a liquid crystal display according to Comparative Example of the present invention.

### DETAILED DESCRIPTION OF THE INVENTION

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

It will be understood that, although the terms first, second, third etc. may be used herein to describe various elements, components, regions, layers, patterns and/or sections, these elements, components, regions, layers, patterns and/or sections should not be limited by these terms. These terms are only used to distinguish one element, component, region, layer pattern or section from another region, layer, pattern or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross sectional illustrations that are schematic illustrations of illustratively idealized example embodiments (and intermediate structures) of the inventive concept. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. The regions illustrated in the figures are schematic in nature and their shapes are not intended to illustrate the actual shape of a region of a device and are not intended to limit the scope of the inventive concept.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The term “pixel” used in the present invention refers to a pixel unit defined by one pixel electrode 191.

In addition, the term “polarity” used in the present invention refers to high and low degrees based on a predetermined voltage, and for example, when a high data voltage applied to a data line based on a common voltage refers to positive polarity (+), and a low data voltage refers to negative polarity (−).

The term “column direction” used in the present invention refers to a downward direction from above, and the term “row direction” refers to a right direction from the left.

Generally, when a direct current (DC) voltage is applied to liquid crystal for a long period of time, degradation in characteristic of the liquid crystal occurs. In order to prevent this, polarity of an applied voltage is periodically changed and a liquid crystal display is driven, which is referred to as a polarity reversal driving method.

The polarity reversal driving method includes a frame inversion driving method, a line inversion driving method, a column inversion driving method, and a dot driving inversion. In this regard, the dot inversion driving method for changing polarity of a data voltage applied to one pixel row realizes most excellent image quality and thus has been generally used.

An RGBW pixel structure including a transparent region in a color filter layer has been proposed in order to enhance luminance of a liquid crystal display and a 2 dot inversion method has been generally used for the RGBW pixel structure.

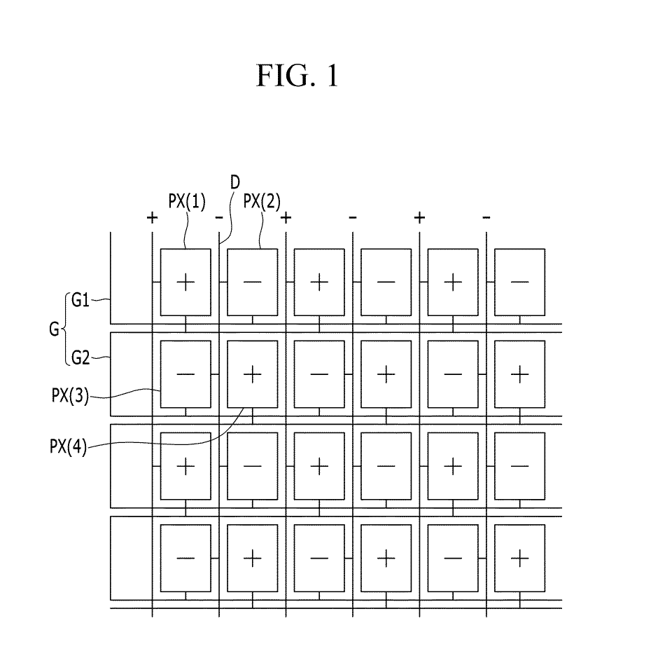

First, with reference to FIG. 1, signal wires and pixel arrangement according to an exemplary embodiment of the present invention will be described below.

FIG. 1 is a schematic diagram illustrating signal wires and pixel arrangement according to an exemplary embodiment of the present invention for explanation of a 2 dot inversion driving method of a liquid crystal display of a RGBW pixel structure.

Referring to FIG. 1, pixels PX of the liquid crystal display according to an exemplary embodiment of the present invention may be disposed in a matrix form.

A plurality of pixels are connected to a plurality of gate lines G arranged in a column direction and a plurality of data lines D that are insulated from and cross the plurality of gate lines G and are arranged in a row direction.

The liquid crystal display according to an exemplary embodiment of the present invention is driven with opposite polarities of data voltages of neighboring pixels in all directions of up, down, right and left directions, which is referred to as 2 dot inversion.

In this case, the liquid crystal display may include a plurality of unit pixels in which four pixels separated by the data lines D and the gate lines G that cross each other are disposed in a 2×2 matrix.

That is, the plurality of unit pixels may include a first pixel PX 1 at row 1 and column 1, a second pixel PX 2 at row 1 and column 2, a third pixel PX 3 at row 2 and column 1, and a fourth pixel PX 4 at row 2 and column 2.

For example, a red display pixel, a green display pixel, a blue display pixel, and a white display pixel may be sequentially and repeatedly formed at row 1 in a right direction, and a blue display pixel, a white display pixel, a red display pixel, and a green display pixel may be sequentially and repeatedly formed at row 2 in a right direction.

The first pixel PX 1 of a first unit pixel may be a red display pixel, the second pixel PX 2 of the first unit pixel may be a green display pixel, the third pixel PX 3 of the first unit pixel may be a blue display pixel, the fourth pixel PX 4 of the first unit pixel may be a white display pixel, the first pixel PX 1 of a second unit pixel that is adjacent to the first unit pixel in a row direction may be a blue display pixel, the second pixel PX 2 of the second unit pixel may be a white display pixel, the third pixel PX 3 of the second unit pixel may be a red display pixel, and the fourth pixel PX 4 of the second unit pixel may be a green display pixel.

In this case, polarities of common voltages of data voltages applied to the first pixel PX 1 and the fourth pixel PX 4 that are disposed in a diagonal direction may be the same, and polarities of common voltages of data voltages applied to the second pixel PX 2 and the third pixel PX 3 that are disposed in an inverse-diagonal direction may also be the same.

In addition, polarity of a common voltage of a data voltage applied to the first pixel PX 1 is opposite to polarity of a common voltage of a data voltage applied to the second pixel PX 2 and the third pixel PX 3 that are adjacent to the first pixel PX 1 in a row direction or a column direction.

For example, the first pixel PX 1 and the fourth pixel PX 4 may exhibit positive polarity (+), and the second pixel PX 2 and the third pixel PX 3 may exhibit negative polarity (−).

Furthermore, although not shown, according to another exemplary embodiment of the present invention, a plurality of unit pixels adjacent in a column direction may exhibit the same polarity and a plurality of unit pixels adjacent in a row direction may exhibit different polarities.

For example, all of the first pixel PX 1, the second pixel PX 2, the third pixel PX 3, and the fourth pixel PX 4 included in the first unit pixel exhibit positive polarity (+), and all of the first pixel PX 1, the second pixel PX 2, the third pixel PX 3, and the fourth pixel PX 4 of the second unit pixel adjacent to the first unit pixel in a row direction may exhibit negative polarity (−). In addition, all of the first pixel PX 1, the second pixel PX 2, the third pixel PX 3, and the fourth pixel PX 4 of the second unit pixel adjacent to the first unit pixel in a column direction may exhibit positive polarity (+).

The unit pixel may be repeatedly formed in a column direction or a row direction.

First gate lines G1 and second gate lines G2 are disposed in parallel to each other between a plurality of pixels adjacent in a column direction, that is, between the first pixel PX 1 and the third pixel PX 3 and between the second pixel PX 2 and the fourth pixel PX 4.

The first gate lines G1 may be adjacent in a column direction and connected to a (2n−1)th pixel (n is a natural number) in a row direction, and the second gate lines G2 may be adjacent in a column direction and connected to a 2nth pixel (n is a natural number) in row direction.

For example, the first gate lines G1 may be connected to the first pixel PX 1 and the third pixel PX 3 that are adjacent to each other in a column direction, and connection with the first pixel PX 1 and connection with the third pixel PX 3 may be performed at different rows.

In this case, the first gate lines G1 that are adjacent to each other in a column direction may be connected to each other outside a pixel area.

That is, the first gate lines G1 may be connected to the first pixel PX 1 and the third pixel PX 3 that are adjacent to each other in a column direction at different rows so as to simultaneously drive the first pixel PX 1 and the third pixel PX 3.

The second gate lines G2 may be connected to the second pixel PX 2 and the fourth pixel PX 4 that are adjacent to each other in a column direction, and connection with the second pixel PX 2 and connection with the fourth pixel PX 4 may be performed at different rows.

In this case, the second gate lines G2 that are adjacent to each other in a column direction may be connected to each other outside a pixel area.

The second gate lines G2 may also be connected to the second pixel PX 2 and the fourth pixel PX 4 that are adjacent to each other in a column direction at different rows so as to simultaneously drive the second pixel PX 2 and the fourth pixel PX 4.

The data lines D may be disposed such that positive polarity (+) and negative polarity (−) are alternately arranged between a plurality of pixels adjacent to each other in a row direction.

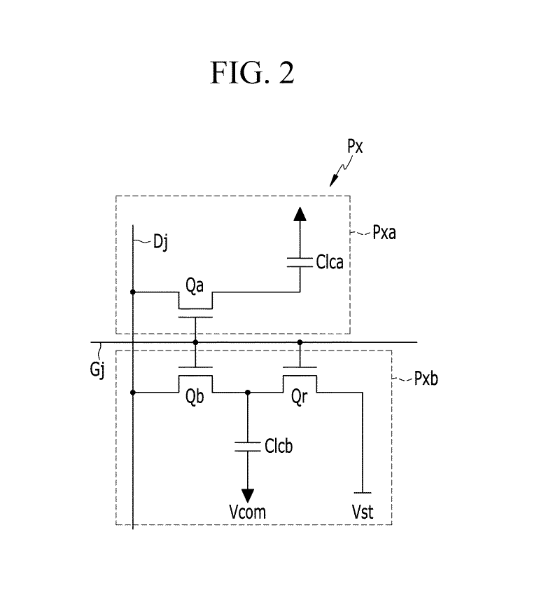

Hereinafter, with reference to FIGS. 2 to 5, a liquid crystal display according to an exemplary embodiment of the present invention will be described in detail.

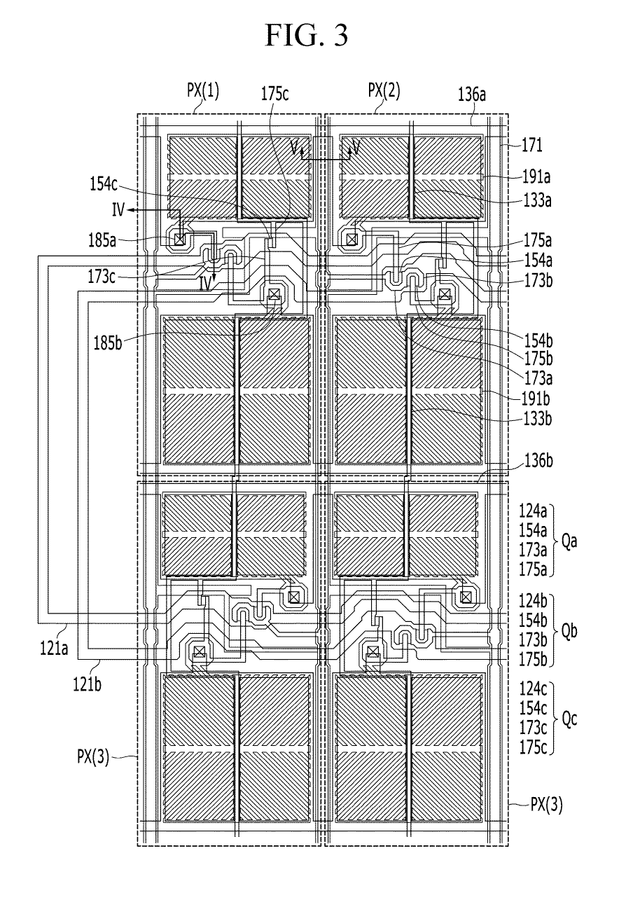

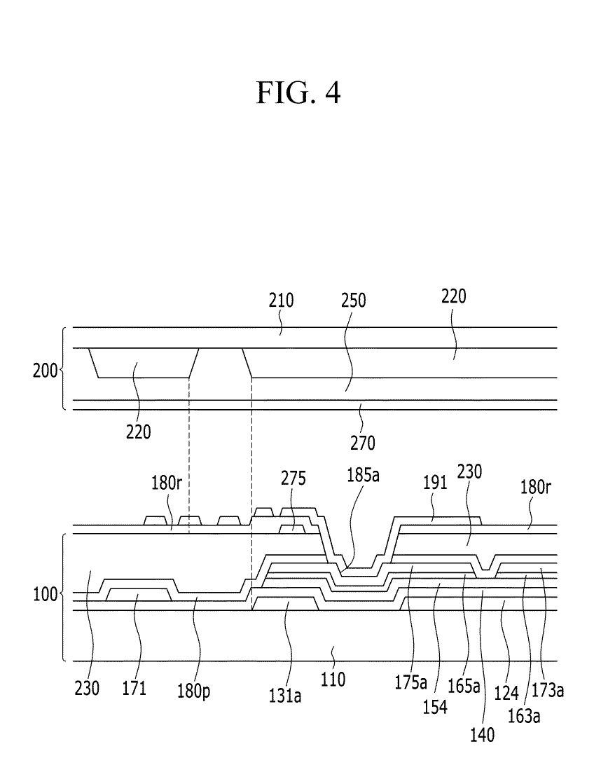

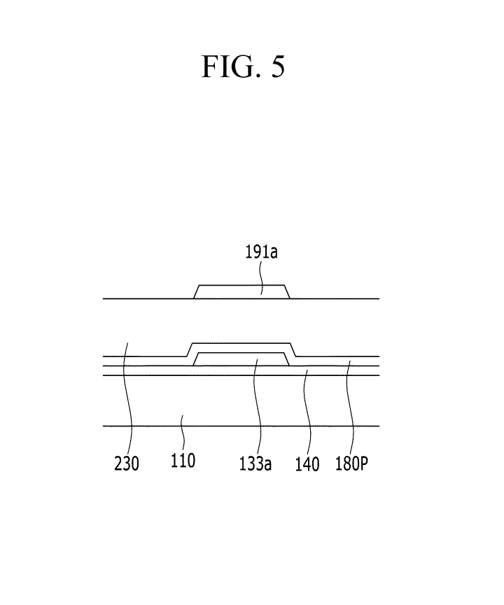

FIG. 2 is a circuit diagram of one pixel of a liquid crystal display according to an exemplary embodiment of the present invention, FIG. 3 is a top plan view of a unit pixel of a liquid crystal display according to an exemplary embodiment of the present invention, FIG. 4 is a cross-sectional view taken along a line IV-IV of FIG. 3, and FIG. 5 is a cross-sectional view taken along a line V-V of FIG. 3.

First, referring to FIG. 2, one pixel PX included in the liquid crystal display according to an exemplary embodiment of the present invention includes a first subpixel PXa and a second subpixel PXb. The first subpixel PXa includes a first switching element Qa connected to at least one data line Dj and at least one gate line Gi, and a first liquid crystal capacitor Clca connected to the first switching element Qa, and the second subpixel PXb includes a second switching element Qb connected to at least one data line Dj and at least one gate line Gi, a dividing switching element Qr, and a second liquid crystal capacitor Clcb connected to the second switching element Qb and the dividing switching element Qr.

The first switching element Qa is a three-terminal element such as a thin film transistor and includes a control terminal connected to the gate line Gi, an input terminal connected to the data line Dj, and an output terminal connected to the first liquid crystal capacitor Clca. In a driving method according to the present invention, the first switching element Qa may be controlled according to a gate signal transmitted by the gate line Gi to transmit a data voltage transmitted by the data line Dj to the first liquid crystal capacitor Clca.

The second switching element Qb is a three-terminal element such as a thin film transistor and includes a control terminal connected to the gate line Gi, an input terminal connected to the data line Dj, and an output terminal connected to the second liquid crystal capacitor Clcb and an input terminal of the dividing switching element Qr. According to a driving method according to the present invention, the second switching element Qb may be controlled according to a gate signal transmitted by the gate line Gi to transmit a data voltage transmitted by the data line Dj to the second liquid crystal capacitor Clcb.

The dividing switching element Qr is a three-terminal element such as a thin film transistor and includes a control terminal connected to the gate line Gi, an input terminal connected to an output terminal of the second switching element Qb, and an output terminal connected to a reference voltage line Vst. The dividing switching element Qr may be controlled according to a gate signal transmitted by the gate line Gi. In addition, when the dividing switching element Qr and the second switching element Qb are turned on, a data voltage transmitted by the data line Dj may be divided by the second switching element Qb and the dividing switching element Qr and transmitted to the second liquid crystal capacitor Clcb.

The first subpixel PXa and the second subpixel PXb may display images according to different gamma curves with respect to one input image signal IDAT and display images with respect to the same gamma curve. Here, the gamma curve refers to a curved line showing luminance or transmittance with respect to gray of the input image signal IDAT.

According to an exemplary embodiment of the present invention, a gamma curve complied by the second subpixel PXb may be adjusted according to control of a resistance ratio of the dividing switching element Qr and the second switching element Qb or a reference voltage. As such, a charging voltage of the second liquid crystal capacitor Clcb may be adjusted under control of the dividing switching element Qr and a reference voltage so as to change luminance of two subpixels PXa and Pxb, and a voltage Clca charged in the first liquid crystal capacitor Clca and a voltage changed in the second liquid crystal capacitor Clcb may be appropriately adjusted to approximate an image viewed from the side to an image viewed from the front, thereby improving side visibility.

Referring to FIGS. 3 to 5, a unit pixel of the liquid crystal display according to an exemplary embodiment of the present invention may include the first pixel PX 1, the second pixel PX 2, the third pixel PX 3, and the fourth pixel PX 4.

First, a lower panel 100 will be described below.

A gate conductor may be formed on a first insulation substrate 110 formed of transparent glass or plastic. The gate conductor includes a gate line 121 that extends in a horizontal direction in a pixel area, first storage electrode lines 131a and 131b that are horizontally positioned on and above a gate line, and second storage electrode lines 136a and 136b that are horizontally positioned on and above an edge of a pixel area.

In this case, the gate line 121 includes a first gate line 121a and a second gate line 121b that are disposed in parallel to each other in the pixel area.

The first gate lines 121a are configured in such a way that a horizontal line that extends in a horizontal direction in a first pixel area PX 1 and a second pixel area PX 2 and a horizontal line that extends in a horizontal direction in a third pixel area PX 3 and a fourth pixel area PX 4 are connected to each other outside the pixel area.

The second gate lines 121b are also configured in such a way that a horizontal line that extends in a horizontal direction in the first pixel area PX 1 and the second pixel area PX 2 and a horizontal line that extends in a horizontal direction in the third pixel area PX 3 and the fourth pixel area PX 4 are connected to each other outside the pixel area.

In this case, the first gate line 121a may be connected to a pixel electrode positioned in the first pixel area PX 1 and a pixel electrode positioned in the third pixel area PX 3 at different rows.

The second gate line 121b may be also connected to a pixel electrode positioned in the second pixel area PX 2 and a pixel electrode positioned in the fourth pixel area PX 4 at different rows.

A gate insulating layer 140 may be positioned on the gate line 121 and storage electrode lines 131a and 131b.

A first semiconductor 154a, a second semiconductor 154b, and a third semiconductor 154c are positioned on the gate insulating layer 140.

The first semiconductor 154a, the second semiconductor 154b, and the third semiconductor 154c are positioned on the gate insulating layer 140 to overlap the first gate line 121a or the second gate line 121b.

For example, the first semiconductor 154a, the second semiconductor 154b, and the third semiconductor 154c that are positioned in the first pixel area PX 1 and the third pixel area PX 3 that are adjacent to each other in a column direction may be positioned to overlap the first gate line 121a, and the first semiconductor 154a, the second semiconductor 154b, and the third semiconductor 154c that are positioned in the second pixel area PX 2 and the fourth pixel area PX 4 that are adjacent to each other in a column direction may be positioned to overlap the second gate line 121b.

A plurality of ohmic contacts 163a, 165a, 163b, 165b, 163c, and 165c are positioned on the semiconductors 154a, 154b, and 154c. However, when the semiconductors 154a, 154b, and 154c are oxide semiconductors, the plurality of ohmic contacts 163a, 165a, 163b, 165b, 163c, and 165c may be omitted.

A plurality of data lines 171 including a first source electrode 173a and a second source electrode 173b, and a data conductor including a first drain electrode 175a, a second drain electrode 175b, a third source electrode 173c, and a third drain electrode 175c are positioned on the plurality of ohmic contacts 163a, 165a, 163b, 165b, 163c, and 165c and the gate insulating layer 140.

In this case, the data conductor, the semiconductors positioned below the data conductor, and the ohmic contacts may be simultaneously formed using one mask.

The first source electrode 173a and the first drain electrode 175a constitute one first switching element (or first thin film transistor) (thin film transistor (TFT)) Qa together with the first semiconductor 154a, and a channel of a thin film transistor may be formed on the semiconductor 154a between the first source electrode 173a and the first drain electrode 175a. Similarly, a second gate electrode 124b, the second source electrode 173b, and the second drain electrode 175b constitute one second switching element (or second thin film transistor) Qb together with the second semiconductor 154b, a channel may be formed on the semiconductor 154b between the second source electrode 173b and the second drain electrode 175b, a third gate electrode 124c, the third source electrode 173c, and the third drain electrode 175c constitute one third switching element (or dividing switching element, third thin film transistor) (Qc) together with the third semiconductor 154c, and a channel may be formed on the semiconductor 154c between the third source electrode 173c and the third drain electrode 175c. In this case, the second drain electrode 175b may be connected to the third source electrode 173c.

A first passivation layer 180p may be positioned on data conductors 171, 173c, 175a, 175b, and 175c and exposed portions of the semiconductors 154a, 154b, and 154c. The first passivation layer 180p may include an inorganic insulating layer such as silicon nitride or silicon oxide. The first passivation layer 180p may prevent pigment of a color filter 230 from being introduced into exposed portions of the semiconductors 154a, 154b, and 154c.

The color filter 230 may be positioned on the first passivation layer 180p. The color filter 230 extends in a vertical direction along two adjacent data lines 171.

The color filter 230 according to an exemplary embodiment of the present invention may be formed of a material with low dielectric constant (k), thereby preventing coupling between a reference voltage line 133a and a pixel electrode 191a that are spaced apart from each other by a predetermined interval by the color filter 230, as shown in FIG. 5.

A second passivation layer 180r may be positioned on the color filter 230.

A first contact hole 185a and a second contact hole 185b through which the first drain electrode 175a and the second drain electrode 175b are exposed are formed in the first passivation layer 180p and the second passivation layer 180r.

The first contact hole 185a may be positioned between a first gate line 185a and the first subpixel electrode 191a that will be described later, and the second contact hole 185b may be positioned between a second gate line 185b and a second subpixel electrode 191b that will be described later.

A plurality of pixel electrodes 191 are positioned on the second passivation layer 180r. The pixel electrodes 191 are separated across the gate line 121 and include the first subpixel electrode 191a and the second subpixel electrode 191b that are adjacent in a column direction based on the gate line 121. The pixel electrode 191 may be formed of a transparent material such as ITO and IZO. The pixel electrode 191 may be formed of reflective metal such as aluminum, silver, chromium or alloy thereof.

An overall shape of the first subpixel electrode 191a and the second subpixel electrode 191b is a quadrangle and includes a cross stem portion including a horizontal stem portion and a vertical stem portion perpendicular thereto, and a fine branch portion that extends from the cross stem portion. A shape of the pixel electrode 191 will be described in more detail.

Vertical portions 133a and 133b of a reference voltage line are positioned to overlap vertical stem portions of the first subpixel electrode 191a and the second subpixel electrode 191b, respectively. In this case, the width of the vertical portions 133a and 133b may be smaller than the width of a vertical stem portion of a subpixel electrode.

The first subpixel electrode 191a and the second subpixel electrode 191b are physically and electrically connected to the first drain electrode 175a and the second drain electrode 175b through the first contact hole 185a and the second contact hole 185b, respectively, and receive a data voltage from the first drain electrode 175a and the second drain electrode 175b. In this case, a portion of a data voltage applied to the second drain electrode 175b is divided through the third source electrode 173c, and amplitude of a voltage applied to the first subpixel electrode 191a is higher than amplitude of a voltage applied to the second subpixel electrode 191b.

The first subpixel electrode 191a and the second subpixel electrode 191b to which a data voltage may be applied generates an electric field together with a common electrode 270 of an upper panel 200 to determine a direction of liquid crystal molecules of a liquid crystal layer 3 between the two electrodes 191 and 270. According to the determined direction of liquid crystal molecules, luminance of light passing through the liquid crystal layer 3 is changed.

Hereinafter, the upper panel 200 will be described.

A light blocking member 220 may be formed on a second insulation substrate 210 formed of transparent glass or plastic. The light blocking member 220 is referred to as a black matrix and prevents light leakage. Throughout this specification, the case in which the light blocking member 220 may be positioned on the upper panel 200 is illustrated, but the present invention is not limited thereto. Needless to say, the light blocking member 220 may be positioned on the lower panel 100.

The light blocking member 220 may be formed to entirely cover a region in which the first switching element Qa, the second switching element Qb, and the dividing switching element Qr of the lower panel 100 and the first to third contact holes 185a, 185b, and 185c are positioned and extends in the same direction as the gate line 121 to overlap a portion of the data line 171. The light blocking member 220 may be positioned to overlap as least portions of the two data lines 171 positioned next to opposite sides of one pixel area so as to prevent light leakage that may occurs around the data line 171 and the gate line 121 and to prevent light leakage in a region in which the plurality of switching elements Qa, Qb, and Qc are positioned.

An overcoat 250 may be positioned on the light blocking member 220. The overcoat 250 may be formed of an (organic) insulating material and may provide a flat surface. The overcoat 250 may be omitted. The common electrode 270 may be positioned on the overcoat 250.

An upper alignment layer (not shown) may be positioned on the common electrode 270 and may be a vertical alignment layer.

The liquid crystal layer 3 has negative dielectric anisotropy and a major axis of liquid crystal molecules of the liquid crystal layer 3 may be aligned to be perpendicular to surfaces of the two display panels 100 and 200 in a state in which an electric field is not present.

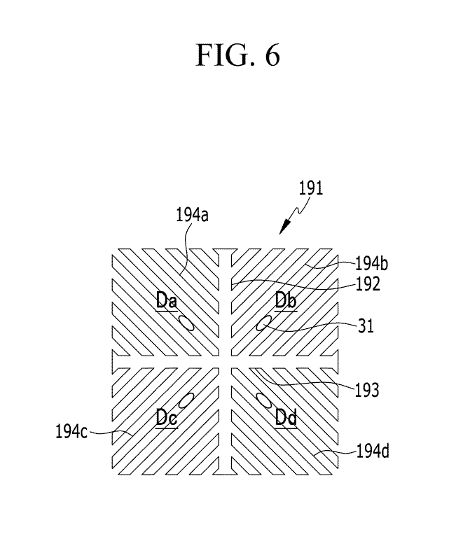

With reference to FIG. 6, a basic electrode of a crystal display according to an exemplary embodiment of the present invention will be described below. FIG. 6 is a top plan view illustrating one basic region of a field generating electrode of a liquid crystal display according to an exemplary embodiment of the present invention.

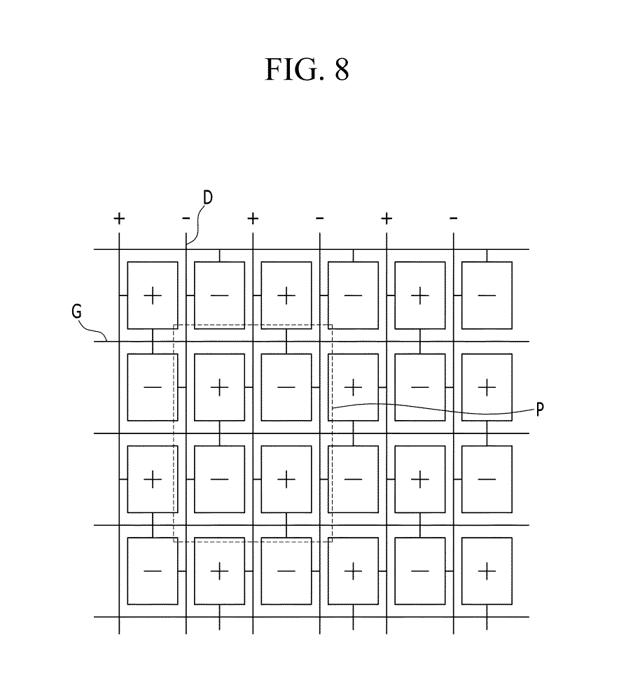

Referring to FIG. 8, an overall shape of the basic electrode 191 is a quadrangle and includes a cross stem portion including a horizontal stem portion 193 and a vertical stem portion 192 perpendicular thereto. In addition, the basic electrode 191 is divided into a first subregion Da, a second subregion Db, a third subregion Dc, and a fourth subregion Dd by the horizontal stem portion 193 and the vertical stem portion 192 and each of the subregions Da to Dd includes a plurality of first to fourth fine branch portions 194a, 194b, 194c, and 194d.

The first fine branch portion 194a diagonally extends in a left-upward direction from the horizontal stem portion 193 or the vertical stem portion 192, and the second fine branch portion 194b diagonally extends in a right-upward direction from the horizontal stem portion 193 or the vertical stem portion 192. In addition, the third fine branch portion 194c diagonally extends in a left-downward direction from the horizontal stem portion 193 or the vertical stem portion 192, and the fourth fine branch portion 194d diagonally extends in a right-downward direction from the horizontal stem portion 193 or the vertical stem portion 192.

The first to fourth fine branch portions 194a, 194b, 194c, and 194d make an angle of about 45 or 135 degrees with respect to the gate line 121a or the horizontal stem portion 193. In addition, the fine branch portions 194a, 194b, 194c, and 194d of two neighboring subregions of the subregions Da, Db, Dc, and Dd may be perpendicular to each other.

When an electric field is applied to the liquid crystal layer 3, sides of the first to fourth fine branch portions 194a, 194b, 194c, and 194d forms a fringe field. Accordingly, liquid crystal molecules 31 are inclined in parallel to a length direction of the fine branch portions 194a, 194b, 194c, and 194d.

The basic electrode 191 includes four subregions Da to Dd including the fine branch portions 194a, 194b, 194c, and 194d with different length directions, and thus inclination directions of the liquid crystal molecules 31 are about four directions, and four domains with different alignment directions of the liquid crystal molecules 31 are formed on the liquid crystal layer 3. As such, when inclination directions of liquid crystal molecules are different, a reference viewing angle of a display device is increased.

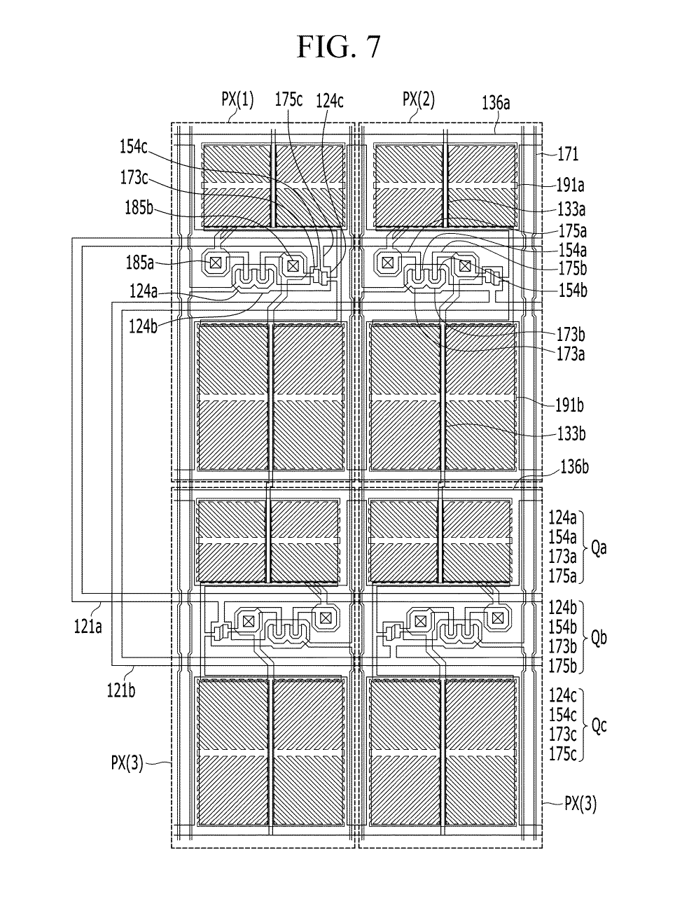

Hereinafter, with reference to FIG. 7, a liquid crystal display according to another exemplary embodiment of the present invention will be described.

FIG. 7 is a plane view of a unit pixel of a liquid crystal display according to another exemplary embodiment of the present invention and is the same as the aforementioned liquid crystal display of FIG. 3 except that a position of thin film transistor (thin film transistor (TFT)) Qa is changed. Accordingly, the reference numeral is denoted for the same constituent, and thus a detailed description thereof will be omitted.

Referring to FIG. 7, a unit pixel of the liquid crystal display according to an exemplary embodiment of the present invention may include the first pixel PX 1, the second pixel PX 2, the third pixel PX 3, and the fourth pixel PX 4.

The gate line 121 includes the first gate line 121a and the second gate line 121b that are disposed in parallel to each other in a pixel area.

Each pixel area may include a first thin film transistor Qa, a second thin film transistor Qb, and a third thin film transistor Qc.

The first thin film transistor Qa may include a first gate electrode 124a, the first semiconductor 154a, the first source electrode 173a, and the first drain electrode 175a, the second thin film transistor Qb may include a second gate electrode 124b, a first semiconductor 154b, a first source electrode 173b, and a first drain electrode 175b, and the third thin film transistor Qc may include a first gate electrode 124c, a first semiconductor 154c, a first source electrode 173c, and a first drain electrode 175c.

In this case, the first thin film transistor Qa, the second thin film transistor Qb, and the third thin film transistor Qc are positioned in an island form between the first gate line 121a and the second gate line 121b.

In addition, the first contact hole 185a and the second contact hole 185b are also positioned in an island form between the first gate line 121a and the second gate line 121b.

In this case, the first thin film transistor Qa, the second thin film transistor Qb, and the third thin film transistor Qc may be disposed in parallel to the first contact hole 185a and the second contact hole 185b in a horizontal direction.

Compared with the liquid crystal display according to an exemplary embodiment of the present invention illustrated in FIG. 3, a parasitic capacitor between the gate line 121 and drain electrode 175 may be reduced and an aperture ratio may be increased.

In detail, referring to FIG. 3, the liquid crystal display according to an exemplary embodiment of the present invention may be configured in such a way that the first thin film transistor Qa, the second thin film transistor Qb, and the third thin film transistor Qc are positioned to overlap the first gate line 121a and the second gate line 121b, and the first contact hole 185a and the second contact hole 185b are positioned outside the first gate line 121a and the second gate line 121b, respectively.

The first thin film transistor Qa, the second thin film transistor Qb, and the third thin film transistor Qc, and the first contact hole 185a and the second contact hole 185b may be disposed in a diagonal direction or a vertical direction.

In addition, the first gate line 121a and the first drain electrode 175a cross each other and the second gate line 121b and the second drain electrode 175b cross each other to generate a parasitic capacitor between the gate line 121 and the drain electrode 175.

Referring back to FIG. 7, the liquid crystal display according to another exemplary embodiment of the present invention may be configured in such a way that the first thin film transistor Qa, the second thin film transistor Qb, and the third thin film transistor Qc are disposed in parallel to the first contact hole 185a and the second contact hole 185b in a horizontal direction so as to reduce the width of the light blocking member 220, thereby improving an aperture ratio.

In addition, the first gate line 121a and the first drain electrode 175a may not cross each other and the second gate line 121b and the second drain electrode 175b may not cross each other, thereby reducing a parasitic capacitor between the gate line 121 and the drain electrode 175.

Hereinafter, with reference to FIGS. 8 to 11, a liquid crystal display according to Comparative Example of the present invention will be described.

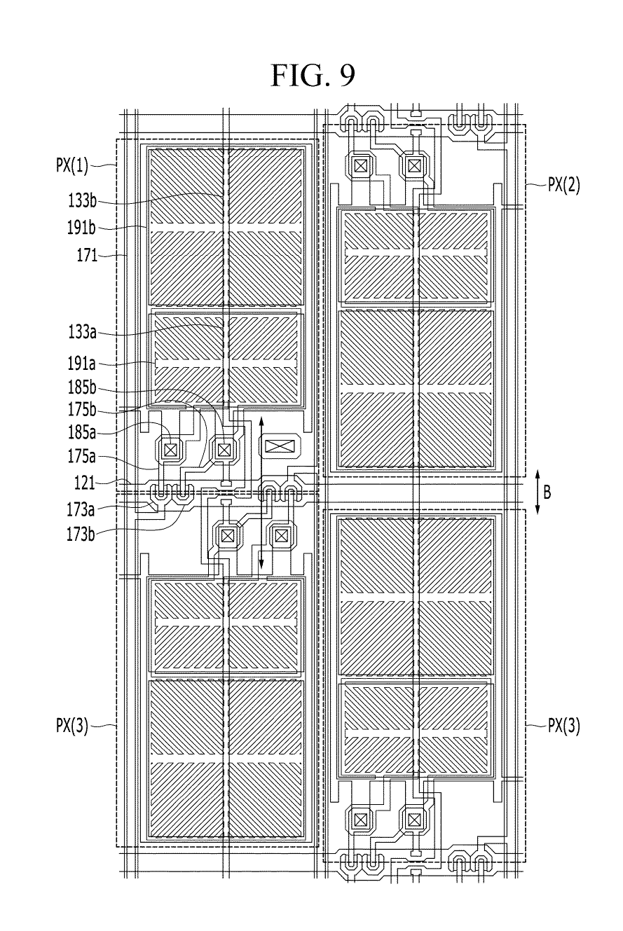

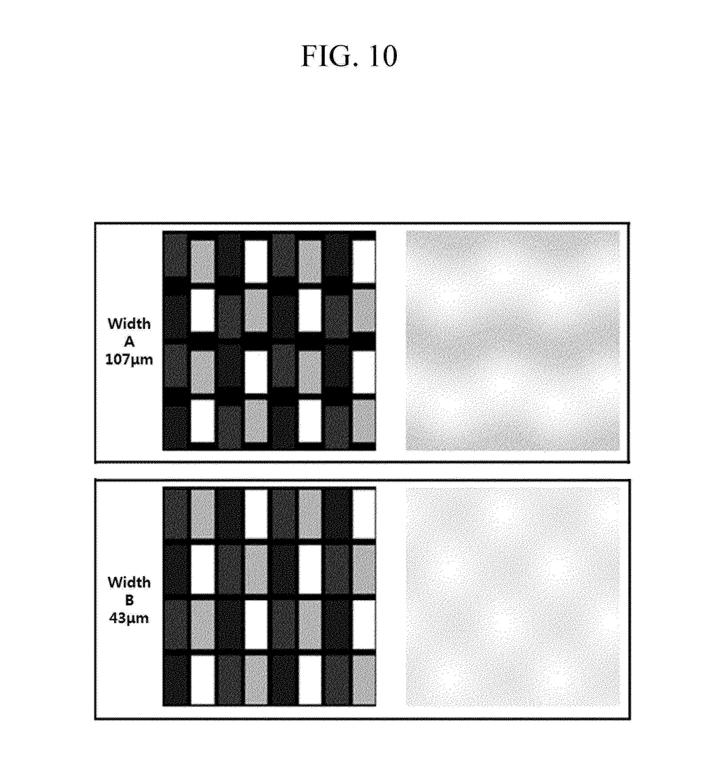

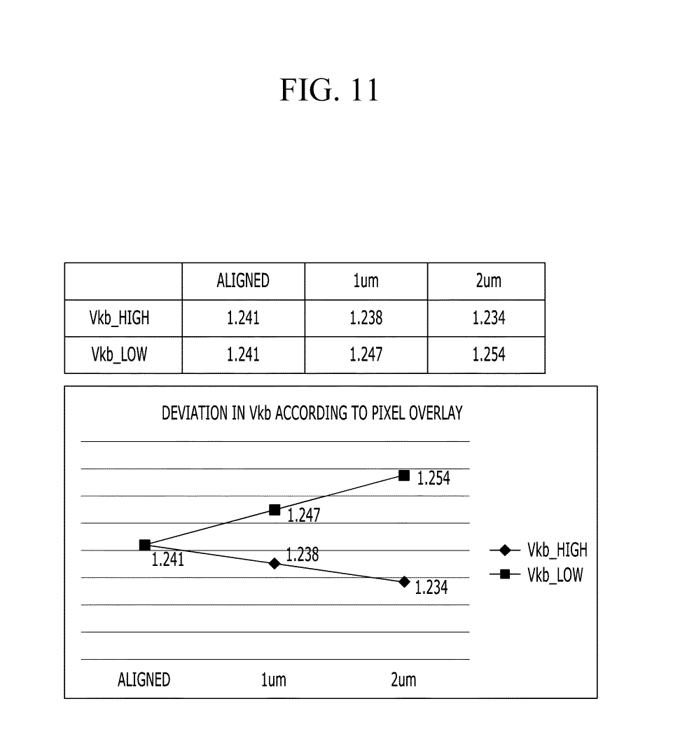

FIG. 8 is a schematic diagram of signal wires and pixel arrangement according to Comparative Example of the present invention, FIG. 9 is a plan view of a unit pixel of a liquid crystal display according to Comparative Example of the present invention and a top plan view of a unit pixel of a region P of FIG. 8, FIG. 10 is a drawing illustrating horizontal unevenness of a liquid crystal display according to Comparative Example of the present invention, and FIG. 11 is a drawing for explanation of deviation of a kickback voltage of a liquid crystal display according to Comparative Example of the present invention.

First, referring to FIG. 8, pixels PX of the liquid crystal display according Comparative Example of the present invention may be disposed in a matrix form.

The liquid crystal display according to Comparative Example of the present invention may be driven with opposite polarities of data voltages of neighboring pixels in all directions of up, down, right and left directions, and four pixels may include a plurality of unit pixels in which four pixels are disposed in a 2×2 matrix.

In this case, one gate line G may be disposed between a plurality of pixels disposed in a column direction, and one data line D may be disposed between a plurality of pixels disposed in a row direction.

The gate lines G may be disposed to be odd numbered or even numbered in a row direction and may be simultaneously connected with a neighboring pixel in a column direction, and the data lines D may be connected to pixels that are disposed in a column direction in a zigzag form.

That is, the data line D may be disposed such that positive polarity (+) and negative polarity (−) are alternately arranged between a plurality of pixels adjacent to each other in a row direction.

Hereinafter, with reference to FIG. 9, a unit pixel of the liquid crystal display according to Comparative Example of the present invention may include the first pixel PX 1, the second pixel PX 2, the third pixel PX 3, and the fourth pixel PX 4.

One gate line 121 extends between the first pixel PX 1 and the third pixel PX 3 and between the second pixel PX 2 and the fourth pixel PX 4.

In this case, the gate line 121 disposed between the first pixel PX 1 and the third pixel PX 3 is simultaneously connected to the first pixel PX 1 and the third pixel PX 3, and the gate line 121 disposed between the second pixel PX 2 and the fourth pixel PX 4 is not connected to the second pixel PX 2 and the fourth pixel PX 4.

That is, a thin film transistor connected to the first pixel PX 1 and the third pixel PX 3 may be disposed between the first pixel PX 1 and the third pixel PX 3, and a thin film transistor connected to the second pixel PX 2 and the fourth pixel PX 4 is not disposed between the second pixel PX 2 and the fourth pixel PX 4.

Accordingly, a width A of a light blocking member formed between the first pixel PX 1 and the third pixel PX 3 may be formed to be wider than a width B of a light blocking member between the second pixel PX 2 and the fourth pixel PX 4.

Referring to FIG. 10, the width A of a light blocking member formed between the first pixel PX 1 and the third pixel PX 3 and the width B of a light blocking member formed between the second pixel PX 2 and the fourth pixel PX 4 may be different, and thus a problem arises in that horizontal unevenness in which bright and dark lines are separated.

Referring back to FIG. 9, a plurality of pixels of the liquid crystal display according to Comparative Example of the present invention may include the first subpixel electrode 191a and the second subpixel electrode 191b.

The first pixel PX 1 and the second pixel PX 2 that are adjacent to each other in a row direction are configured in such a way that the first subpixel electrode 191a and the second subpixel electrode 191b of the first pixel PX 1 are arranged in an opposite vertical direction to those of the second pixel PX 2, and the third pixel PX 3 and the fourth pixel PX 4 that are adjacent to each other in a row direction are configured in such a way that the first subpixel electrode 191a and the second subpixel electrode 191b of the third pixel PX 3 are arranged in an opposite vertical direction to those of the fourth pixel PX 4. Thus, when the first insulation substrate and the second insulation substrate are misaligned with each other, deviation in a kickback voltage Vkb generated by parasitic capacitance between terminals of a switching element, particularly, between the gate line 121 and the pixel electrode 191 occurs.

As seen from FIG. 11, as a misaligned interval between the first insulation substrate and the second insulation substrate of the liquid crystal display according to Comparative Example of the present invention is increased, high deviation in kickback voltage Vkb occurs.

The liquid crystal display according to an exemplary embodiment of the present invention may include the first gate line 121a and the second gate line 121b that are disposed in parallel to each other in a pixel area, the first gate line G1 and the second gate line G2 may be simultaneously connected to pixels that are adjacent thereto in a column direction, respectively, the first gate line 121a may be connected to one pixel that is adjacent thereto in a row direction, and the second gate line 121b may be connected to the other pixel that is adjacent thereto in a row direction such that light blocking members between the pixels adjacent to each other in a column direction have the same width so as to reduce horizontal unevenness and to reduce deviation in a kickback voltage generated by parasitic capacitance between terminals of a switching element, thereby improving image quality.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A liquid crystal display comprising:
a plurality of gate lines and a plurality of data lines that is insulated from and cross the plurality of gate lines; and
a plurality of unit pixels connected to the plurality of gate lines and the plurality of data lines,
wherein:
the plurality of unit pixel includes a first pixel at row 1 and column 1, a second pixel at row 1 and column 2, a third pixel at row 2 and column 1, and a fourth pixel at row 2 and column 2,
a first gate line and a second gate line are disposed in parallel to each other between the first pixel and the third pixel and between the second pixel and the fourth pixel; and
the first gate line is connected to the first pixel and the third pixel at different neighboring rows, and the second gate line is connected to the second pixel and the fourth pixel at different neighboring rows.

2. The liquid crystal display of claim 1, wherein:
the first gate lines that are adjacent to each other in a column direction are connected to each other outside a pixel area, and the second gate lines that are adjacent to each other in a column direction are connected to each other outside a pixel area.

3. The liquid crystal display of claim 1, wherein:
the plurality of data lines are disposed between a plurality of pixels that are adjacent to each other in a row direction; and
a plurality of pixels disposed in a row direction alternately have positive polarity (+) and negative polarity (−).

4. The liquid crystal display of claim 3, wherein:
the positive polarity (+) and the negative polarity (−) are opposite polarities to common voltages of data voltages applied to the plurality of data lines.

5. The liquid crystal display of claim 3, wherein:
the plurality of data lines are alternately connected to a plurality of pixels disposed in a column direction in a zigzag form.

6. The liquid crystal display of claim 1, wherein:
the column direction is a downward direction from above and the row direction is a right direction from the left.

7. The liquid crystal display of claim 1, wherein:
the unit pixel is divided by the gate line and the data line that cross each other.

8. The liquid crystal display of claim 7, wherein:
the first pixel is a red display pixel, the second pixel is a green display pixel, the third pixel is a blue display pixel, and the fourth pixel is a white display pixel.

9. The liquid crystal display of claim 1, wherein:
the plurality of pixels include a first subpixel electrode and a second subpixel electrode.

10. The liquid crystal display of claim 9, wherein:
the first gate line and the second gate line are disposed in parallel to each other between the first subpixel electrode and the second subpixel electrode.

11. The liquid crystal display of claim 12, further comprising:
a first thin film transistor connected to the first subpixel electrode;
a second thin film transistor connected to the second subpixel electrode; and
a third thin film transistor connected to the second thin film transistor and a reference voltage line.

12. The liquid crystal display of claim 11, wherein:
the first to third thin film transistors include a gate electrode, a semiconductor layer, and source electrode and drain electrodes; and
the drain electrode and the first and second subpixel electrode are connected to each other through a contact hole.

13. The liquid crystal display of claim 12, wherein:
the first thin film transistor, the second thin film transistor, and the third thin film transistor are positioned on the first gate line or the second gate line.

14. The liquid crystal display of claim 13, wherein:
the contact hole is disposed between the first and second gate lines and the first and second subpixel electrodes.

15. The liquid crystal display of claim 14, wherein:
the first thin film transistor, the second thin film transistor, the third thin film transistor, and the contact hole are disposed between the first gate line and the second gate line.

16. The liquid crystal display of claim 15, wherein:
the first thin film transistor, the second thin film transistor, the third thin film transistor, and the contact hole are disposed in parallel to each other in a horizontal direction.

17. A liquid crystal display, comprising:
a plurality of gate lines and a plurality of data lines that is insulated from and cross the plurality of gate lines; and
a plurality of unit pixels connected to the plurality of gate lines and the plurality of data lines,
wherein the plurality of unit pixel comprises:
a first pixel at row 1 and column 1, a second pixel at row 1 and column 2, a third pixel at row 2 and column 1, and a fourth pixel at row 2 and column 2; and
a first gate line and a second gate line are disposed in parallel to each other between the first pixel and the third pixel and between the second pixel and the fourth pixel, the first gate line is connected to the first pixel and the third pixel at different neighboring rows, and the second gate line is connected to the second pixel and the fourth pixel at different neighboring rows,
wherein the plurality of unit pixels adjacent in a column direction exhibit the same polarity and the plurality of unit pixels adjacent in a row direction exhibit a different polarity.
